(19) United States
(12) Patent Application Publication
(10) Pub. No.: US 2019/0287048 A1
(43) Pub. Date: Sep. 19, 2019

(54) TRIGGER BASED DELIVERY METHOD AND SYSTEM

(71) Applicant: HOP NGUYEN NGO, PEARLAND, TX (US)

(72) Inventor: HOP NGUYEN NGO, PEARLAND, TX (US)

(21) Appl. No.: 16/352,400

(22) Filed: Mar. 13, 2019

Related U.S. Application Data
(60) Provisional application No. 62/645,131, filed on Mar. 19, 2018.

(51) Int. Cl. G06Q 10/08

(52) U.S. Cl. CPC G06Q 10/083

(57) ABSTRACT

A trigger based delivery method and system is disclosed for performing the delivery of specified materials and additional information determined by one or more triggers set by a first user, using the condition-triggered automation tool, to a second user, resulting in the disbursement of specified materials and additional information from the destination location to the second user.

### FIELD OF THE INVENTION

The present invention relates to a trigger based delivery method and system for the delivery of specified materials and additional information using one or more triggers. The invention concerns a method for storing specified materials for delayed delivery and completing requests based on one or more triggers within the requests using a condition-triggered automation tool.

### BACKGROUND

Traditionally, the physical delivery of items is driven by a sender's request. Senders initiate the immediate delivery of specified items through a third party, such as Amazon.

Today, there are many forms of delivery on the market allowing for the prescheduled delivery of items to a particular location. However, the current market lacks the user ability to delay the delivery of the items, which may be outcome determinative based on the happening of a particular event set by a user.

The present invention addresses the problem with the current delivery methods on the market by utilising a condition-triggered automation tool, releasing specified materials that are specific in time and request.

The present invention comprises a condition-triggered automation tool, meaning that if a triggering event, a specific event, a specific input or a stimulation occurs, then a responding task, a specific response, a specific task or a specific action is triggered, activated, started or enabled in response thereto.

Accordingly, the specificity of the request is determined by one or more triggers using the condition-triggered automation tool, set by a first user at the time the request is initiated. A user, defined as either the sender or receiver, initiates the request.

Additionally, the present invention allows for the storage of one or more triggers and specified materials and additional information at a particular location set by the first user, including data indicative of a delay, to administer to a second user.

Moreover, the present invention allows the delay to be outcome determinative based on the happening of a stated event.

Thus, there is a need for a trigger based delivery method and system that allows a user the ability to delay the delivery of specified materials and additional information, using the condition-triggered automation tool, such as the one described herein.

### SUMMARY

The present invention provides a trigger based delivery method and system for completing a first user initiated request using one or more triggers provided within the requests to a second user. The first user attaches one or more triggers to specified material and additional information which may include data indicative of a delay. In turn, the destination location stores and processes the first user request detected. The second user initiates a separate, independent request by attaching one or more triggers to the second user request. The system of the present invention detects the matching triggers, set by a first user and a second user, resulting in the disbursement of specified materials and additional information from the destination location to the second user.

The use of triggers provides a large degree of flexibility in storing specified materials and additional information for delayed delivery. The triggers also permit a first user the ability to request immediate or delayed delivery of the specified material and additional information to a second user.

In addition, the trigger based delivery method and system of the present invention provides functionality and usability, allowing a user the ability to delay delivery of specified materials and additional information, based on one or more triggers using a condition-triggered automation tool.

### BRIEF DESCRIPTION OF THE FIGURES

Embodiments of the present invention will now be described, by way of example only, with reference to the accompanying figures.

FIG. 1 illustrates a diagram showing the trigger based delivery method and system in accordance with the principles of the present invention.

FIG. 2 illustrates a diagram showing the steps for the trigger based delivery method and system in accordance with the principles of the present invention.

### DETAILED DESCRIPTION OF THE INVENTION

The following detailed description is merely exemplary in nature and is not intended to limit the disclosure or the application and uses of the disclosure. As used herein, the word “exemplary” means “serving as an example, instance, or illustration.” Thus, any embodiment described herein as “exemplary” is not necessarily to be construed as preferred or advantageous over other embodiments. Furthermore, there is no intention to be bound by any expressed or implied theory presented in the preceding technical field, background, brief summary, or the following detailed description.

In this description, reference is made to the drawings, wherein like parts are designated with like reference numerals throughout. As used in the description herein and throughout, the meaning of “a,” “an,” and “said” includes plural reference unless the context clearly dictates otherwise. Also, as used in the description herein, the meaning of “in” includes “into” and “on” unless the context clearly dictates otherwise.

As used in this description, the terms “component,” “database,” “module,” “system,” and the like are intended to broadly capture a computer-related entity, either hardware, firmware, a combination of hardware and software, software, or software in execution. For example, a component may be, but is not limited to being, a process running on a processor, a processor, an object, an executable, a thread of execution, a program, and/or a computer.

As used in this description, the term “trigger” is defined as a response caused by a particular action, process, or situation.

As used in this description, the term “specified material” is defined as the intentional and deliberate material designated to the second user by the first user. Also, the term “additional information” is defined as the detailed information, used as supplementary information to the specified material, designated to the second user by the first user.

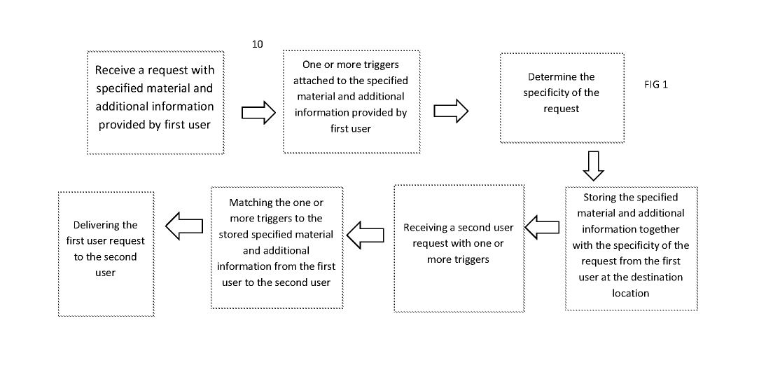

The trigger based delivery method and system 10 is designed to receive a request from the first user 20 with specified material 101 and additional information 102, attaching one or more triggers 103 from the first user 20 to the specified material 101 and additional information 102, determining the specificity of the request 106, storing the one or more triggers 103 and the specified material 101 and additional information 102 together with the specificity of the request 106 from the first user 20 to a destination location 104, receiving a second user 30 request with the one or more triggers 103; matching the one or more triggers 103 and the specified material 101 and the additional information 102 together with the specificity of the request 106 from the first user 20 to the second user 30; and delivering the first user 20 request to the second user 30. (see FIG. 1).

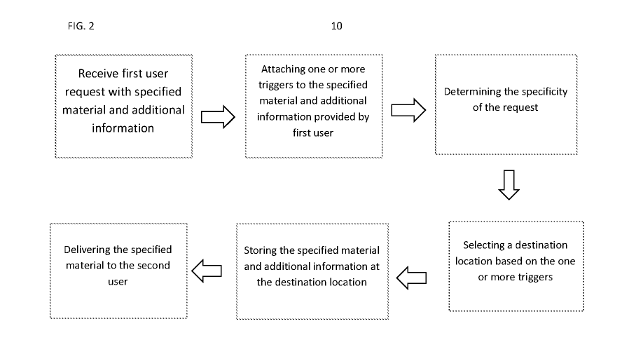

In an exemplary embodiment, trigger based delivery method and system 10 comprises receiving a first user 20 request with specified material 101 and additional information 102 (step 200), attaching one or more triggers 103 to the specified material 101 and additional information 102 (step 201), determining the specificity of one or more triggers 103 (step 202), selecting a destination location 104 based on the specificity of one or more triggers 103 (step 203), storing the specified material 101 and additional information 102 at the destination location 104 (step 204), and delivering the specified material 101 and additional information 102 to a second user 30 (step 205). (see FIG. 2).

All of the embodiments described herein are exemplary embodiments provided to enable persons skilled in the art to make or use the disclosure and not to limit the scope of the disclosure that is defined by the claims.

1. A trigger based delivery method and system comprising the steps of:
a) receiving a first user request with specified material and additional information, using the specified material and additional information, no sooner than a specified time;
b) attaching one or more triggers provided by the first user request to the specified material and additional information;
c) determining specificity of request from the first user request;
d) storing the one or more triggers and the specified material and the additional information together with the specificity of the request from the first user request at a destination location;
e) receiving a second user request with the one or more triggers;
f) matching the one or more triggers and the specified material and the additional information together with the specificity of the request from the first user request to the second user request; and
g) delivering the first user request to the second user request.

2. The trigger based delivery method and system of claim 1, wherein the one or more triggers are specified by the first user request according to a time parameter or quality parameter.

3. The trigger based delivery method and system of claim 1, wherein the specified materials and the additional information including data indicative of a delay.

4. The trigger based delivery method and system of claim 1, wherein the first user request or the second user request determines, based at least in part on the request, a delivery time estimate identifying an estimated amount of time required to transport the item from the source location to the destination location.

5. The trigger based delivery method and system of claim 1, wherein the destination location is at least one of a secure delivery location, a materials handling facility, or a user designated delivery location.
